(19) United States
(12) Patent Application Publication
(10) Pub. No.: US 2019/0181495 A1
(43) Pub. Date: Jun. 13, 2019

(54) LITHIUM ION SECONDARY BATTERY AND METHOD FOR PRODUCING THE SAME

(71) Applicant: Panasonic Intellectual Property Management Co., Ltd., Osaka-shi, Osaka (JP)

(72) Inventors: Yuji Tani, Osaka (JP); Hajime Nishino, Nara (JP); Yasuhiro Sugaya, Osaka (JP); Satoshi Nishitani, Osaka (JP)

(73) Assignee: Panasonic Intellectual Property Management Co., Ltd., Osaka-shi, Osaka (JP)

(21) Appl. No.: 16/322,721

(22) PCT Filed: May 19, 2017
(86) PCT No.: PCT/JP2017/018771

§ 371 Date: Feb. 1, 2019

(30) Foreign Application Priority Data
Aug. 5, 2016 (JP) 2016-154673

(51) Int. Cl. H01M 10/0525; H01M 4/38; H01M 10/0568; H01M 10/058

(52) U.S. Cl. CPC H01M 10/0525; H01M 4/386; H01M 2004/027; H01M 10/058; H01M 10/0568

(57) ABSTRACT

A lithium ion secondary battery includes a positive electrode, a negative electrode, a separator disposed between the positive electrode and the negative electrode, and a nonaqueous electrolyte having permeated the positive electrode, the negative electrode and the separator. The nonaqueous electrolyte includes a lithium salt and a nonaqueous solvent in which the lithium salt is dissolved. The lithium salt concentration in the nonaqueous electrolyte present within the positive electrode is higher than the lithium salt concentration in the nonaqueous electrolyte present within the negative electrode.

### TECHNICAL FIELD

The present invention relates to improvements in discharge characteristics of lithium ion secondary batteries.

### BACKGROUND ART

Lithium ion secondary batteries have a positive electrode, a negative electrode and a separator. These electrodes and separator are impregnated with a nonaqueous electrolyte containing a lithium salt. The nonaqueous electrolyte has fluidity, and therefore the lithium salt concentration within the electrodes and the separator is usually uniform.

To reduce the overpotential during high-current charging and discharging, it has been proposed that the nonaqueous electrolyte is held on a gel-like polymer, and the lithium salt concentration within the positive electrode and/or the negative electrode is set higher than that within the separator (Patent Literature 1).

### CITATION LIST

### Patent Literature

PTL 1: Japanese Published Unexamined Patent Application No. 2002-298919

### SUMMARY OF INVENTION

During discharging, lithium ion secondary batteries release lithium ions from the negative electrode into the nonaqueous electrolyte. The lithium ions that are released migrate through the nonaqueous electrolyte and are adsorbed to the positive electrode. In high-current discharging, the supply of lithium ions into the inside of the positive electrode cannot keep up with the electron transfer, and the lithium salt concentration within the positive electrode is decreased, with the result that a sufficient discharge capacity is not obtained at times. In particular, the lithium salt concentration within the positive electrode is markedly lowered after charging and discharging cycles are repeated.

In light of the above circumstance, an aspect of the present disclosure resides in a lithium ion secondary battery including a positive electrode, a negative electrode, a separator disposed between the positive electrode and the negative electrode, and a nonaqueous electrolyte having permeated the positive electrode, the negative electrode and the separator, the nonaqueous electrolyte including a lithium salt and a nonaqueous solvent in which the lithium salt is dissolved. The lithium salt concentration in the nonaqueous electrolyte present within the positive electrode is higher than the lithium salt concentration in the nonaqueous electrolyte present within the negative electrode.

Another aspect of the present disclosure resides in a method for producing a lithium ion secondary battery, including a step of forming an electrode assembly including a positive electrode, a negative electrode and a separator disposed between the positive electrode and the negative electrode, a step of impregnating the electrode assembly with a nonaqueous electrolyte including a lithium salt and a nonaqueous solvent in which the lithium salt is dissolved, and a step of adding a lithium salt to the positive electrode before the electrode assembly is impregnated with the nonaqueous electrolyte.

The techniques according to the above aspects of the present disclosure can overcome the shortage of lithium salt within the positive electrode during high-current discharging. Thus, the lithium ion secondary batteries that are provided attain excellent discharge characteristics.

### BRIEF DESCRIPTION OF DRAWING

FIG. 1 is a vertical sectional view of a nonaqueous electrolyte secondary battery according to an embodiment of the present invention.

### DESCRIPTION OF EMBODIMENTS

A lithium ion secondary battery of the present invention includes a positive electrode, a negative electrode, a separator disposed between the positive electrode and the negative electrode, and a nonaqueous electrolyte having permeated the positive electrode, the negative electrode and the separator. The nonaqueous electrolyte includes a lithium salt and a nonaqueous solvent in which the lithium salt is dissolved. The lithium salt concentration (SCp) in the nonaqueous electrolyte present within the positive electrode is higher than the lithium salt concentration (SCn) in the nonaqueous electrolyte present within the negative electrode.

Here, SCp and SCn are the lithium salt concentrations in the lithium ion secondary battery measured in the discharged state (at 0% state of charge (SOC)). While the lithium ion secondary battery used in the measurement of lithium salt concentrations is preferably fresh (in the initial state after production and shipment), the battery may not be new as long as SCp>SCn is obtained.

The discharged state with 0% SOC means that the battery voltage is equal to the discharge cut-off voltage. Lithium ion secondary batteries are usually discharged in a charging and discharging circuit offered by manufacturers to a discharge cut-off voltage established by the manufacturers. Thus, the discharged state with 0% SOC can be uniquely defined depending on the manufacturers and types of the lithium ion secondary batteries.

During discharging, lithium ions are adsorbed to the positive electrode, and therefore the lithium salt concentration within the positive electrode is decreased. When the lithium salt concentration within the positive electrode in the initial discharged state is elevated beforehand, a plenty of lithium ions can be present within the positive electrode even during high-current discharging. As a result, the adsorption reaction of lithium ions to the positive electrode is promoted, and a sufficient discharge capacity can be ensured.

To ensure a higher discharge capacity during high-current discharging, the ratio of SCp to SCn (SCp/Scn) is preferably larger than 1.0, more preferably 1.1 or more, and particularly preferably 1.5 or more. The upper limit of SCp is not particularly limited. However, if the lithium salt concentration within the positive electrode is excessively high, the average concentration of the lithium salt in the nonaqueous electrolyte is also raised. Consequently, the nonaqueous electrolyte comes to exhibit an increased viscosity, and the migration of the lithium salt tends to be inhibited. Thus, the ratio SCp/SCn is preferably not more than 2.0.

The average concentration (SCa) of the lithium salt in the nonaqueous electrolyte is preferably not less than 1.8 mol/L, and more preferably not less than 2.0 mol/L. This average concentration ensures that there will be sufficient amounts of lithium ions also within the separator and the negative electrode. That is, the positive electrode can contain a sufficient amount of lithium ions during high-current discharging, and also outstanding charge and discharge characteristics are attained easily. To avoid an excessive increase in the viscosity of the nonaqueous electrolyte, the average concentration of the lithium salt in the nonaqueous electrolyte is preferably not more than 5.0 mol/L. The average concentration (SCa) of the lithium salt is determined from the total amount of the lithium salt and the total amount of the nonaqueous solvent in the lithium ion secondary battery. Thus, SCp is higher than SCa, and SCn is lower than SCa.

Next, there will be described how SCp, SCn and SCa are measured.

The lithium ion secondary battery in the discharged state (SOC=0%) which will be subjected to the measurement is disassembled, and the electrode assembly impregnated with the nonaqueous electrolyte is cut to give specimens (10 mm×50 mm) of the positive electrode, the negative electrode and the separator.

The specimens are placed into aluminum foil-containing laminate bags having an inner size of 40 mm×80 mm, and are soaked in 1 mL of γ-butyrolactone (GBL). The bags are then thermally sealed, and the lithium salt is extracted approximately for one day. The extraction liquids obtained are filtered through a polytetrafluoroethylene (PTFE) filter having a pore size of 0.45 μm. The filtrates are placed into PTFE measuring flasks, and water is added to a total volume of 100 mL. The resultant solutions of water and the extraction liquid are analyzed by ion chromatography (IC) to determine the amounts of the lithium salt contained in the extraction liquids. The calibration curve necessary for IC determination is prepared using several samples of nonaqueous electrolyte having known concentrations.

Separately, the void volumes of the specimens (the positive electrode active material layer, the negative electrode active material layer, and the separator) are measured. Assuming that the void volumes are equal to the volumes of the nonaqueous electrolyte that has penetrated in the specimens, calculations are made to determine SCp, SCn, and the concentration (SCs) of the lithium salt in the nonaqueous electrolyte contained in the pores of the separator.

The void volumes of the specimens are measured as follows. The specimens after extraction of the lithium salt are sufficiently washed with dimethyl carbonate (DMC) and are dried at 100° C. for 1 hour. Next, the dried specimens (the active material layers and the separator) are analyzed on a helium pycnometer to determine the respective total pore volumes. The total pore volumes obtained correspond to the void volumes per unit area of the specimens (the positive electrode, the negative electrode, and the separator).

Next, the total pore volumes of the respective specimens are converted to the total pore volumes of the positive electrode, the negative electrode and the separator that are present in the electrode assembly, and the sum of these volumes is obtained as the total pore volume of the electrode assembly. From the total pore volumes of the positive electrode, the negative electrode and the separator that are present in the electrode assembly, and SCp, SCn and SCs, the amounts of the lithium salt contained in the entireties of the positive electrode, the negative electrode and the separator are determined. The amounts are then combined to give the amount of the lithium salt contained in the electrode assembly. Then, SCa is calculated assuming that the total pore volume of the electrode assembly is equal to the volume of the nonaqueous electrolyte that has penetrated in the electrode assembly.

The lithium ion secondary battery according to an embodiment of the present invention includes a wound electrode assembly. The wound electrode assembly may be obtained by winding a long sheet of the negative electrode and a long sheet of the positive electrode into a coil through the separator therebetween. The electrode assembly and the nonaqueous electrolyte are accommodated in a battery case. These constituents will be described below.

### (Positive Electrodes)

The positive electrode in the form of a long sheet includes a positive electrode current collector and a positive electrode active material layer held on the positive electrode current collector. The positive electrode active material layer is usually formed on both sides of the positive electrode current collector. The positive electrode active material layer includes a positive electrode active material and a binder, and may include optional components such as a conductive agent as required.

The positive electrode active material layer is formed by applying a positive electrode slurry including components such as a positive electrode active material, a binder and a dispersion medium onto the surface of the positive electrode current collector, followed by drying and pressing. Examples of the dispersion media include water, alcohols such as ethanol, ethers such as tetrahydrofuran, and N-methyl-2-pyrrolidone (NMP).

For example, the positive electrode current collector may be a metal foil or a metal sheet. Some example materials of the positive electrode current collectors are stainless steel, aluminum, aluminum alloys and titanium. The thickness of the positive electrode current collector may be selected from the range of, for example, 5 to 20 μm.

For example, the positive electrode active material is a lithium-containing composite oxide. Some example transition metal elements which may be used are Sc, Y, Mn, Fe, Co, Ni, Cu and Cr. Preferred transition metals are, among others, Mn, Co and Ni. Specific examples of the lithium-containing composite oxides include, but are not particularly limited to, LiCoO₂, LiNiO₂, LiMn₂O₄, LiCo₁₋ₓMₓO₂ (M is a metal element other than Co, and 0<x<0.3) and LiNi₁₋ₓCoₓAl_{y}O₂ (0.05<x<0.2, and 0.03<y<0.08).

To increase the capacity of a lithium ion secondary battery, there is a demand that a positive electrode active material layer contains a positive electrode active material with an increased density. Further, a wound electrode assembly is required to have thicker positive and negative electrodes so that the volume occupied by a separator will be reduced. If, however, the density of a positive electrode active material is increased, the porosity of the positive electrode active material layer is correspondingly decreased, which means that the amount in which the active material layer is impregnated with a nonaqueous electrolyte is reduced. This fact intensifies the need of increasing the lithium salt concentration within the positive electrode. Further, with increasing thickness of the positive electrode active material layer, it becomes more difficult to supply lithium ions to the positive electrode active material present near the positive electrode current collector. This fact too intensifies the need of increasing the lithium salt concentration within the positive electrode.

In the lithium ion secondary battery according to an embodiment of the present invention, the porosity in the positive electrode active material layer is as low as not more than 20% in order to attain an increase in capacity. In spite of such a low porosity, a sufficient amount of lithium ions can be ensured within the positive electrode and a sufficient discharge capacity can be obtained by virtue of the SCp/SCn ratio being greater than 1. The lower limit of the porosity in the positive electrode active material layer is 15%. It is difficult to reduce the porosity below this value.

The porosity is measured in the manner described below.

Similarly as described hereinabove, the total pore volume of a specimen (the positive electrode active material layer) is measured with a helium pycnometer. Separately, the volume of the positive electrode active material layer present in the specimen is calculated from the size of the specimen and the thickness of the positive electrode active material layer. The porosity is then calculated from the proportion of the total pore volume to the volume of the positive electrode active material layer.

In the lithium ion secondary battery according to an embodiment of the present invention, the thickness of the positive electrode active material layer is as large as 80 μm or more, or further 85 μm or more in order to attain an increase in capacity. In spite of such a large thickness, a sufficient amount of lithium ions can be ensured within the positive electrode as far as to the vicinity of the positive electrode current collector, and a sufficient discharge capacity can be obtained by virtue of the SCp/SCn ratio being greater than 1. The thickness of the positive electrode active material layer is the distance from the surface of one side of the positive electrode current collector to the surface, of the positive electrode active material layer disposed on that surface of the current collector, that is adjacent to the separator. If the positive electrode active material layer is too thick, less merits are obtained by limiting the SCp/SCn ratio to greater than 1. It is therefore preferable that the thickness of the positive electrode active material layer be not more than 150 μm.

Where the positive electrode active material is LiCoO₂ or LiCo₁₋ₓMₓO₂ (M is a metal element other than Co, and 0<x<0.3), the density of the positive electrode active material contained in the positive electrode active material layer is preferably not less than 3.6 g/cm³ in order to attain an increase in capacity. Here, the upper limit of the density of the positive electrode active material is 4.3 g/cm³. It is difficult to increase the density above this value.

Where the positive electrode active material is LiNiO₂ or LiNi₁₋ₓCoₓAl_{y}O₂ (0.05<x<0.2, and 0.03<y<0.08), the density of the positive electrode active material contained in the positive electrode active material layer is preferably not less than 3.65 g/cm³ in order to attain an increase in capacity. Here, the upper limit of the density of the positive electrode active material is 4.0 g/cm³. It is difficult to increase the density above this value.

The density of the positive electrode active material contained in the positive electrode active material layer is measured in the following manner.

The lithium ion secondary battery in the discharged state (SOC=0%) which will be subjected to the measurement is disassembled, and the electrode assembly impregnated with the nonaqueous electrolyte is removed and decomposed into the positive electrode, the negative electrode and the separator. Next, the positive electrode is washed with DMC to remove the nonaqueous electrolyte, and is dried at 100° C. for 1 hour. The dried positive electrode is cut to give a 20 mm×20 mm specimen having the positive electrode active material layers over the entirety of both sides. The volume of the positive electrode active material layers is calculated from the size of the specimen and the thicknesses of the positive electrode active material layers. Separately, the positive electrode active material layers are separated from the specimen, and the positive electrode active material is isolated. The density is then calculated from the mass of the isolated positive electrode active material and the volume of the positive electrode active material layers.

### (Negative Electrodes)

The negative electrode in the form of a long sheet includes a negative electrode current collector and a negative electrode active material layer held on the negative electrode current collector. The negative electrode active material layer is usually formed on both sides of the negative electrode current collector. The negative electrode active material layer includes a negative electrode active material and a binder, and may include optional components such as a conductive agent as required.

The negative electrode active material layer is formed by applying a negative electrode slurry including components such as a negative electrode active material, a binder and a dispersion medium onto the surface of the negative electrode current collector, followed by drying and pressing. Examples of the dispersion media include water, alcohols such as ethanol, ethers such as tetrahydrofuran, and N-methyl-2-pyrrolidone (NMP).

For example, the negative electrode current collector may be a metal foil, a metal sheet, a mesh, a punched sheet or an expanded metal. Some example materials of the negative electrode current collectors are stainless steel, nickel, copper and copper alloys. The thickness of the negative electrode current collector may be selected from the range of, for example, 5 to 20 μm.

The material of the negative electrode active material layers is not particularly limited. To attain an increase in capacity, among others, carbon materials and silicon materials are preferably used. The carbon material is preferably at least one selected from the group consisting of graphites and hard carbons. In particular, graphites are promising materials because of their high capacity and small irreversible capacity.

The graphites are a collective term for carbon materials having a graphite structure. They include natural graphites, artificial graphites, expanded graphites and graphitized mesophase carbon particles. Carbon materials having a 002 interplanar distance d₀₀₂ in the graphite structure of 3.35 to 3.44 Å as calculated with respect to an X-ray diffraction spectrum are usually classified into the graphites.

The negative electrode present in the lithium ion secondary battery according to an embodiment of the present invention includes a negative electrode current collector and a negative electrode active material layer held on the negative electrode current collector, the negative electrode active material layer containing silicon element. By the incorporation of silicon element into the negative electrode active material layer, the capacity of the negative electrode can be increased. When the negative electrode active material layer contains silicon element, the negative electrode is significantly shrunk during discharging. While the positive electrode too is slightly shrunk during discharging, the shrinkage of the negative electrode is much larger than that of the positive electrode, and therefore the nonaqueous electrolyte tends to be retained in the negative electrode. Consequently, the amount of the nonaqueous electrolyte that is available for the inside of the positive electrode is relatively decreased. Thus, the presence of silicon element in the negative electrode active material layer significantly intensifies the need of increasing the lithium salt concentration within the positive electrode.

The phrase “negative electrode active material layer contains silicon element” means that the negative electrode active material layer contains a silicon material as a negative electrode active material. The silicon material may be elementary silicon or a silicon compound. Examples of the silicon compounds include silicon oxides, silicon nitrides and silicon alloys. In particular, silicon oxides are preferable in that swelling and shrinkage are relatively small.

Where the negative electrode active material layer contains silicon element, the proportion of the silicon material to the whole of the negative electrode active materials is preferably controlled to 1 mass % to 30 mass %, and more preferably 5 mass % to 20 mass % in order to reduce the swelling and shrinkage as much as possible. The whole of the negative electrode active materials preferably includes not less than 70 mass %, or more preferably not less than 80 mass % carbon material.

The amount of the binder contained in the positive electrode active material layer and/or the negative electrode active material layer is preferably 0.1 to 20 parts by mass, and more preferably 1 to 5 parts by mass per 100 parts by mass of the active material. Examples of the binders include fluororesins such as polyvinylidene fluoride (PVDF), polytetrafluoroethylene (PTFE) and tetrafluoroethylene-hexafluoropropylene copolymer (HFP); acrylic resins such as polymethyl acrylate and ethylene-methyl methacrylate copolymer; and rubbery materials such as styrene-butadiene rubber (SBR) and acrylic rubber.

The amount of the conductive agent contained in the positive electrode active material layer and/or the negative electrode active material layer is preferably 0.1 to 20 parts by mass, and more preferably 1 to 5 parts by mass per 100 parts by mass of the active material. Examples of the conductive agents include carbon blacks and carbon fibers.

### (Separators)

Examples of the separators include microporous films, nonwoven fabrics and woven fabrics including resins. Examples of the resins include polyolefins such as polyethylene and polypropylene, polyamides and polyamidimides.

### (Nonaqueous Electrolytes)

The nonaqueous electrolyte includes a lithium salt and a nonaqueous solvent in which the lithium salt is dissolved. The lithium salt concentration (SCp) in the nonaqueous electrolyte present within the positive electrode is higher than the lithium salt concentration (SCn) in the nonaqueous electrolyte present within the negative electrode. While the nonaqueous electrolyte exhibits fluidity at 25° C., a relatively high lithium salt concentration within the positive electrode can be ensured without the need of a gel-like polymer. This is because the lithium salt is unlikely to diffuse within the electrode where the active material layer has a large thickness and a small porosity. The lithium salt is unlikely to diffuse particularly when the lithium ion secondary battery is used in an electric vehicle (EV) where the battery is charged and discharged with short pulsed current. If a gel-like polymer is used, the nonaqueous electrolyte becomes less fluid and therefore the migration speed of lithium ions is reduced, with the result that the discharge capacity during high-current discharging may be lowered.

The type of the nonaqueous solvent is not particularly limited. Examples of the nonaqueous solvents include cyclic carbonate esters such as propylene carbonate (PC) and ethylene carbonate (EC); chain carbonate esters such as diethyl carbonate (DEC), ethyl methyl carbonate (EMC) and dimethyl carbonate (DMC); and cyclic carboxylate esters such as γ-butyrolactone and γ-valerolactone. The nonaqueous solvents may be used singly, or two or more may be used in combination.

Examples of the lithium salts include LiPF₆, LiBF₄, LiClO₄, LiAsF₆, LiCF₃SO₃, LiN(SO₂F)₂ and LiN(SO₂CF₃)₂. The lithium salts may be used singly, or two or more may be used in combination.

As already mentioned, the lithium ion secondary batteries of the present invention do not require a so-called gel-like polymer. Thus, the component which permeates the separator is the fluid nonaqueous electrolyte composed of the nonaqueous solvent and the lithium salt. Substantially no polymer components are present within the separator.

More specifically, when the lithium ion secondary battery is disassembled, and the electrode assembly impregnated with the nonaqueous electrolyte is removed and decomposed, the nonaqueous solvent and the lithium salt usually represent 90 vol % or more of the components extracted from the pores in the separator. In some cases, the binder which has leached from the positive electrode active material layer and the negative electrode active material layer, and polymers originating from additives are dissolved into the nonaqueous electrolyte or are suspended in the nonaqueous electrolyte. Thus, the nonaqueous solvent and the lithium salt do not necessarily represent 100% of the components extracted from the pores in the separator.

Next, some methods for producing the lithium ion secondary batteries will be described.

The lithium ion secondary battery of the present invention may be produced by a method which includes a step (a) of forming an electrode assembly including a positive electrode, a negative electrode and a separator disposed between the positive electrode and the negative electrode, a step (b) of impregnating the electrode assembly with a nonaqueous electrolyte including a lithium salt and a nonaqueous solvent in which the lithium salt is dissolved, and a step (c) of adding a lithium salt to the positive electrode before the electrode assembly is impregnated with the nonaqueous electrolyte. The step (c) is performed prior to the step (b). Usually, the step (c) is performed before the step (a) that takes place before the step (b).

Specifically, the step (c) of adding a lithium salt to the positive electrode before the electrode assembly is impregnated with the nonaqueous electrolyte may be a step (c-1) of adding a lithium salt to a positive electrode slurry to form a positive electrode active material layer containing the lithium salt, or a step (c-2) of, after the formation of a positive electrode active material layer, applying a solution or nonaqueous electrolyte containing a lithium salt to the positive electrode active material layer to cause the lithium salt to penetrate into the positive electrode active material layer.

In the step (c-1), a lithium salt may be mixed with a positive electrode slurry containing components such as a positive electrode active material, a binder and a dispersion medium. To ensure that the lithium salt will be sufficiently dissolved into the dispersion medium, a nonaqueous solvent such as a carbonate ester may be used as at least part of the dispersion medium. The lithium salt is not necessarily dissolved into the dispersion medium. The amount of the lithium salt added to the positive electrode slurry is preferably not more than 20 parts by volume per 100 parts by volume of the positive electrode active material layer.

In the step (c-2), a solution or nonaqueous electrolyte containing a high concentration of a lithium salt may be applied to a positive electrode active material layer that has been dried. Such a solution or nonaqueous electrolyte containing a high concentration of a lithium salt will be hereinafter written as the high lithium concentration liquid. The lithium salt concentration in the high lithium concentration liquid may be any value that does not exceed the saturation concentration. The lithium salt concentration may be, for example, not less than 1.8 mol/L, and preferably not less than 2.0 mol/L. After the high lithium concentration liquid is applied, the positive electrode active material layer may be dried.

Hereinbelow, an example of the lithium ion secondary batteries will be described with respect to a cylindrical wound battery. However, the configurations such as type and shape of the lithium ion secondary batteries are not particularly limited. The electrode assembly is not limited to a wound or laminate structure. The lithium ion secondary batteries may be prismatic batteries, or may be other forms such as pouch batteries having a film exterior case. In particular, the advantageous effects of the present invention are fully taken advantage of when the type of the battery is such that the pouring of a nonaqueous electrolyte with a high lithium salt concentration is difficult. Examples of the types of such batteries include cylindrical batteries, and rectangular batteries having a large electrode plate size.

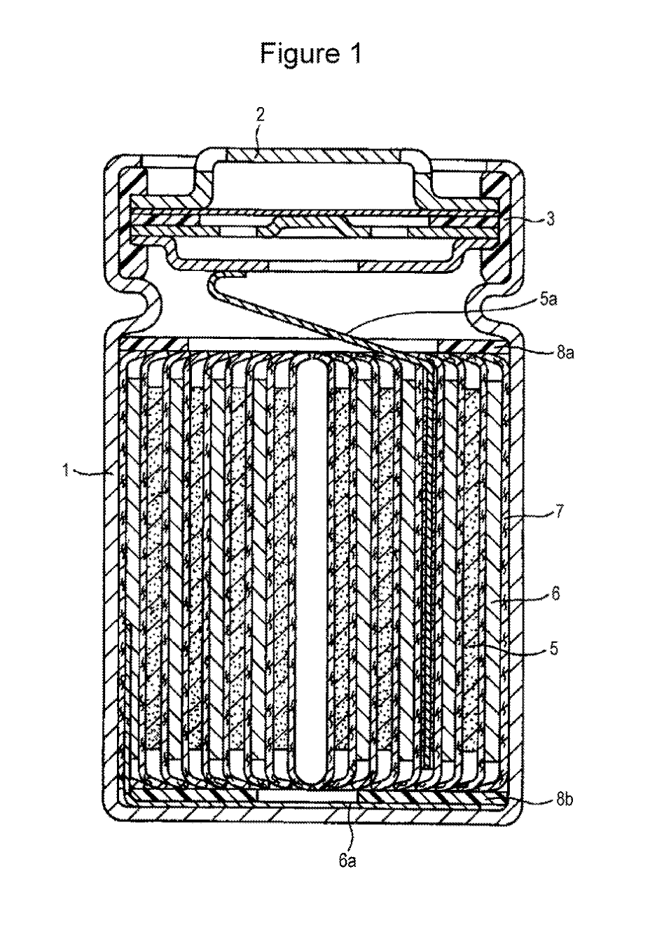

In FIG. 1, a lithium ion secondary battery 10 includes a bottomed battery case 1 having an opening, a sealing plate 2 which closes the opening, a gasket 3 disposed between the open end of the battery case 1 and the sealing plate 2, a wound electrode assembly accommodated in the battery case 1, and a nonaqueous electrolyte (not shown) that has permeated the electrode assembly. The electrode assembly is a coil formed by winding a strip of a positive electrode 5 having a positive electrode lead 5a, and a strip of a negative electrode 6 having a negative electrode lead 6a with a separator 7 disposed therebetween. An upper insulating plate 8a and a lower insulating plate 8b are disposed on the upper and lower end faces of the electrode assembly, respectively. One end of the negative electrode lead 6a is welded to the battery case 1, and one end of the positive electrode lead 5a is connected to the sealing plate 2. In order to lower the internal resistance and to equalize the battery reaction, it is preferable that the positive electrode lead 5a be connected to the vicinity of the center of the positive electrode in the longitudinal direction.

### EXAMPLES

Hereinbelow, the present invention will be described in detail based on EXAMPLES and COMPARATIVE EXAMPLES. However, it should be construed that the scope of the present invention is not limited to such EXAMPLES.

### Example 1

### (a) Fabrication of Positive Electrode

Lithium nickel oxide LiNi_{0.80}Co_{0.15}Al_{0.05}O₂ as a positive electrode active material was prepared. A positive electrode slurry was prepared by mixing 100 parts by mass of the positive electrode active material, 1.0 part by mass of acetylene black as a conductive agent, and an amount of N-methyl-2-pyrrolidone (NMP) solution of PVDF as a binder. The amount of PVDF was 0.9 parts by mass per 100 parts by mass of the positive electrode active material.

### (Positive Electrode)

The positive electrode slurry was applied to both sides of an aluminum foil (15 μm in thickness) as a positive electrode current collector. The films were dried at 110° C. and were pressed with a roller. Positive electrode active material layers were thus formed. In this process, the amount in which the slurry was applied, and the linear pressure of the roller were controlled so that the thicknesses of the two positive electrode active material layers attached to both sides of the positive electrode current collector would be each 70 μm.

Next, a high lithium concentration liquid was provided which contained 2.0 mol/L LiPF₆ dissolved in a solvent mixture of EC and DMC (in a volume ratio of 2:8). This liquid was applied to the dry positive electrode active material layers, and was dried. Thereafter, the positive electrode was cut into a strip.

### (b) Fabrication of Negative Electrode

Spherical artificial graphite having an average particle size of 20 μm was used as a negative electrode active material. A negative electrode slurry was prepared by mixing the artificial graphite particles, styrene butadiene rubber (SBR) as a binder, and water. Here, the amount of SBR was 1.0 part by mass per 100 parts by mass of the artificial graphite particles. The negative electrode slurry was applied to both sides of an electrolytic copper foil (8 μm in thickness) as a negative electrode current collector. The films were dried at 110° C. and were pressed with a roller. Negative electrode active material layers were thus formed. In this process, the amount in which the slurry was applied, and the linear pressure of the roller were controlled so that the thicknesses of the two negative electrode active material layers attached to both sides of the negative electrode current collector would be each 70 μm. Thereafter, the negative electrode obtained was cut into a strip.

### (c) Preparation of Nonaqueous Electrolyte

LiPF₆ was dissolved with a concentration of 1.4 mol/L into a solvent mixture which contained EC and DMC in a volume ratio of 1:3 and contained 5 mass % of vinylene carbonate. A nonaqueous electrolyte was thus prepared.

### (d) Fabrication of Battery

A cylindrical lithium ion secondary battery illustrated in FIG. 1 was fabricated in the following manner.

The strip of the positive electrode was treated so as to expose the positive electrode current collector near the center of the positive electrode in the longitudinal direction. A positive electrode lead 5a made of aluminum was attached to the exposed portion. Separately, the strip of the negative electrode was treated so as to expose the negative electrode current collector at one end of the negative electrode in the longitudinal direction. A negative electrode lead made of nickel was attached to the exposed portion. Thereafter, the positive electrode and the negative electrode were wound together with a separator (20 μm in thickness) disposed therebetween. A cylindrical electrode assembly was thus fabricated. The separator used was a microporous polyethylene film having an aramid layer.

Next, an upper insulating plate and a lower insulating plate were arranged to the upper and lower end faces of the electrode assembly, and the electrode assembly was placed into a bottomed cylindrical battery case having an opening. In this process, the negative electrode lead was welded to the inside of the bottom of the battery case. Thereafter, an annular groove was formed in a portion of the battery case that was above the upper insulating plate and was near the open end of the battery case. The positive electrode lead was welded to the lower face of a sealing plate having a safety valve breakable by inner pressure, and thereafter the nonaqueous electrolyte was poured into the battery case under reduced pressure. The sealing plate was then fitted into the annular groove so as to close the opening of the battery case. A gasket had been arranged beforehand along the periphery of the sealing plate, and the open end of the battery case was crimped to fix the sealing plate through the gasket. A cylindrical 18650-size lithium ion secondary battery (nominal capacity 2500 mAh) was thus fabricated.

The complete lithium ion secondary battery was subjected to preliminary charging and discharging in which the battery was charged at a constant current of 0.3 C to 4.2 V and was thereafter discharged at a constant current of 0.5 C to 2.5 V. A lithium ion secondary battery (A1) in the initial state was thus obtained.

### [Evaluations]

### (1) High-Rate Discharge Characteristics

At 25° C., the lithium ion secondary battery in the discharged state was charged at a constant current of 0.5 C until the battery voltage reached 4.2 V, and was subsequently charged at a constant voltage of 4.2 V until the current value became 50 mA. Thereafter, the battery was discharged at a constant current of 0.2 C to 2.5 V, and the capacity was measured.

After the battery capacity was obtained, the battery was charged at a constant current of 0.3 C and was subsequently charged at a constant voltage of 4.2 V until the current value became 50 mA, and thereafter the battery was discharged at a constant current of 1 C to 2.5 V. This cycle was repeated. The battery capacity obtained by the 1 C discharging in the 2nd cycle was expressed as a percentage ratio to the battery capacity obtained by the 0.2 C discharging, and thereby high-rate discharge characteristics were evaluated. The results are described in Table 1.

### (2) Cycle Characteristics

The above cycle was repeated 500 times. The capacity retention ratio after the 500 cycles was obtained as cycle characteristics. The results are described in Table 1.

### (3) SCp, SCn and SCa

The lithium ion secondary battery in the discharged state for the measurement was disassembled, and the electrode assembly impregnated with the nonaqueous electrolyte was removed and cut to give specimens of the positive electrode, the negative electrode and the separator. SCp, SCn and SCa were calculated by the method described hereinabove. As a result, SCp/SCn was not less than 1.1, and SCa was 1.8 mol/L.

### (4) Porosity of Positive Electrode Active Material Layers

The total pore volume of a specimen (the positive electrode active material layers) was measured with a helium pycnometer by the method described hereinabove. Separately, the volume of the positive electrode active material layers was calculated from the size of the specimen and the thicknesses of the positive electrode active material layers. The porosity was then calculated from the proportion of the total pore volume to the volume of the positive electrode active material layers. The porosity obtained is described in Table 1.

### Example 2

A lithium ion secondary battery (A2) was fabricated in the same manner as in EXAMPLE 1, except that the lithium salt concentration in the high lithium concentration liquid to be applied to the dry positive electrode active material layers, and the concentration of the nonaqueous electrolyte for permeating the electrode assembly were controlled so that SCp/SCn would be not less than 1.1 and SCa would be 2.0 mol/L.

### Example 3

A lithium ion secondary battery (A3) with a nominal capacity of 2700 mAh was fabricated in the same manner as in EXAMPLE 1, except that the thicknesses of the two positive electrode active material layers were each changed to 80 μm.

### Example 4

A lithium ion secondary battery (A4) with a nominal capacity of 2800 mAh was fabricated in the same manner as in EXAMPLE 1, except that the negative electrode active material was changed to a combination of spherical artificial graphite and silicon oxide (SiO).

### Comparative Example 1

A lithium ion secondary battery (B1) having SCp/SCn of 1.0 and SCa of 1.4 mol/L was fabricated in the same manner as in EXAMPLE 1, except that the high lithium concentration liquid was not applied to the dry positive electrode active material layers.

### Comparative Example 2

A lithium ion secondary battery (B2) having SCp/SCn of 1.0 and SCa of 1.8 mol/L was fabricated in the same manner as in EXAMPLE 2, except that the high lithium concentration liquid was not applied to the dry positive electrode active material layers, and the concentration of the nonaqueous electrolyte for permeating the electrode assembly was controlled.

### Comparative Example 3

A lithium ion secondary battery (B3) having SCp/SCn of 1.0 and SCa of 1.4 mol/L was fabricated in the same manner as in EXAMPLE 3. Here, the thicknesses of the two positive electrode active material layers were each changed to 80 μm, but the high lithium concentration liquid was not applied to the dry positive electrode active material layers.

### Comparative Example 4

A lithium ion secondary battery (B4) having SCp/SCn of 1.0 and SCa of 1.4 mol/L was fabricated in the same manner as in EXAMPLE 4 while using the same negative electrode as that used in EXAMPLE 4, except that the high lithium concentration liquid was not applied to the dry positive electrode active material layers.

TABLE 1

| | Positive electrode | | Negative | | | High-rate | |
|---|---|---|---|---|---|---|---|
| | active material layers | | electrode | | | discharge | Cycle |
| | Thickness | Porosity | active | | | characteristics | characteristics |
| Batteries | (μm) | (%) | material | SCp/SCn | SCa | (%) | (%) |
| A1 | 70 | 19.5 | Graphite | 1.1< | 1.8 | 100 | 85 |
| A2 | 70 | 19.5 | Graphite | 1.1< | 2.0 | 100 | 87 |
| A3 | 80 | 20.0 | Graphite | 1.1< | 1.8 | 98 | 80 |
| A4 | 70 | 19.5 | Graphite/SiO | 1.1< | 1.8 | 98 | 83 |
| B1 | 70 | 19.5 | Graphite | 1.0 | 1.4 | 96 | 75 |
| B2 | 70 | 19.5 | Graphite | 1.0 | 1.8 | 90 | 60 |
| B3 | 80 | 20.0 | Graphite | 1.0 | 1.4 | 93 | 68 |
| B4 | 70 | 19.5 | Graphite/SiO | 1.0 | 1.4 | 95 | 72 |

As clear from Table 1, the batteries which involved the pre-application of a lithium salt to the positive electrode satisfied SCp/SCn and attained significant improvements in high-rate discharge characteristics and cycle characteristics compared to the batteries produced without preliminarily applying a lithium salt to the positive electrode.

The battery B2, in which the lithium salt concentration in the nonaqueous electrolyte was uniform within the positive electrode and the negative electrode and the average concentration of the lithium salt was 1.8 mol/L, showed markedly low cycle characteristics due to the increase in viscosity of the nonaqueous electrolyte and the consequent difficulty for the nonaqueous electrolyte to permeate the electrode assembly. It is probable that the internal resistance of the battery B2 was increased.

### INDUSTRIAL APPLICABILITY

The lithium ion secondary batteries according to the present invention may be used in applications such as power supplies for driving personal computers, cellular phones, mobile devices, personal digital assistances (PDAs), portable game devices, video cameras, etc., main power supplies and auxiliary power supplies for driving electric motors in hybrid electric vehicles, fuel cell vehicles, plug-in HEVs, etc., and power supplies for driving power tools, vacuum cleaners, robots, etc.

### REFERENCE SIGNS LIST

1 BATTERY CASE
2 SEALING PLATE
3 GASKET
5a POSITIVE ELECTRODE LEAD
5 POSITIVE ELECTRODE
6a NEGATIVE ELECTRODE LEAD
6 NEGATIVE ELECTRODE
7 SEPARATOR
8a UPPER INSULATING PLATE
8b LOWER INSULATING PLATE
10 LITHIUM ION SECONDARY BATTERY

1. A lithium ion secondary battery comprising a positive electrode, a negative electrode, a separator disposed between the positive electrode and the negative electrode, and a nonaqueous electrolyte having permeated the positive electrode, the negative electrode and the separator, wherein
the nonaqueous electrolyte includes a lithium salt and a nonaqueous solvent in which the lithium salt is dissolved,
the ratio (SCp/SCn) of the lithium salt concentration (SCp) in the nonaqueous electrolyte present within the positive electrode to the lithium salt concentration (SCn) in the nonaqueous electrolyte present within the negative electrode is larger than 1.0, and
the average concentration of the lithium salt in the nonaqueous electrolyte is not less than 1.8 mol/L.

2. (canceled)

3. The lithium ion secondary battery according to claim 1, wherein the positive electrode includes a positive electrode current collector and a positive electrode active material layer held on the positive electrode current collector, and
the porosity in the positive electrode active material layer is not more than 20%.

4. The lithium ion secondary battery according to claim 3, wherein the thickness of the positive electrode active material layer is 80 μm or more.

5. The lithium ion secondary battery according to claim 1, wherein the negative electrode includes a negative electrode current collector and a negative electrode active material layer held on the negative electrode current collector, and
the negative electrode active material layer contains silicon element.

6. A method for producing a lithium ion secondary battery, comprising:
a step of forming an electrode assembly including a positive electrode, a negative electrode and a separator disposed between the positive electrode and the negative electrode,
a step of impregnating the electrode assembly with a nonaqueous electrolyte including a lithium salt and a nonaqueous solvent in which the lithium salt is dissolved, and
a step of adding a lithium salt to the positive electrode before the electrode assembly is impregnated with the nonaqueous electrolyte.
